(19) United States
(12) Patent Application Publication
(10) Pub. No.: US 2008/0073384 A1
(43) Pub. Date: Mar. 27, 2008

(54) Sprayer

(76) Inventor: Jin-Duei Lin, Taichung County (TW)

Correspondence Address: BACON & THOMAS, PLLC, 625 SLATERS LANE, FOURTH FLOOR, ALEXANDRIA, VA, 22314, US

(21) Appl. No.: 11/524,469

(22) Filed: Sep. 21, 2006

(51) Int. Cl. B67D 3/00

(52) U.S. Cl. 222/533

(57) ABSTRACT

A sprayer includes a can, a head, a pressure-releasing pipe, a cap and a button. The head is installed on the can. The pressure-releasing pipe is movably installed on the head. The cap is installed on the head. The button is made independent of the cap and installed on the pressure-releasing pipe within the cap.

### BACKGROUND OF INVENTION

1. Field of Invention

The present invention relates to a sprayer and, more particularly, to a sprayer with which proper operation is ensured.

2. Related Prior Art

Referring to FIG. 4, a typical sprayer includes a can 10, a head 15 installed on the can 10 and a pressure-releasing pipe 16 movably installed on the head 15. Before sealed by the head 15, the can 10 is filled with pressurized gas and liquid. The liquid may be medicine, oil, paint or any other proper liquid. When pushed, the pressure-releasing pipe 16 releases the pressurized gas from the can 10. While traveling from the can 10, the pressurized gas carries the liquid. To prevent a user from contacting the liquid, the head 15 and the pressure-releasing pipe 16 are covered by a cap 20. The cap 20 includes a button 25 elastically formed thereon. The button 25 is formed with an intake 27 for receiving the pressure-releasing pipe 16 and an outlet 26 extending from the cap 20. By pushing the button 25, the user pushes the pressure-releasing pipe 16 so that the liquid and the pressurized air travel from the can 10 through the intake 27 and outlet 26.

Referring to FIG. 5, a sprayer might include a pressure-releasing pipe 16A that is too long. The pressure-releasing pipe 16A is inevitably pushed by the button 25 when the cap 20 is installed on the can 10. The liquid and the pressurized air leak from the can 10.

Referring to FIG. 6, a sprayer might include a pressure-releasing pipe 16B that is too short. The pressure-releasing pipe 16B is separated from the button 25 when the cap 20 is installed on the can 10. The pressure-releasing pipe 16B is not pushed when the button 25 is pushed. The liquid and the pressurized air fail to travel from the can 10 as expected.

Referring to FIG. 7, a sprayer might include a head 15A that is too high. Installed on the head 15A, the pressure-releasing pipe 16 is inevitably pushed by the button 25 when the cap 20 is installed on the can 10. The liquid and the pressurized air leak from the can 10.

Referring to FIG. 8, a sprayer might include a head 15B that is too short. Installed on the head 15B, the pressure-releasing pipe 16 is separated from the button 25 when the cap 20 is installed on the can 10. The pressure-releasing pipe 16 is not pushed when the button 25 is pushed. The liquid and the pressurized air fail to travel from the can 10 as expected.

Therefore, the present invention is intended to obviate or at least alleviate the problems encountered in prior art.

### SUMMARY OF INVENTION

It is the primary objective of the present invention to provide a sprayer with which proper operation is ensured.

According to the present invention, a sprayer includes a can, a head, a pressure-releasing pipe, a cap and a button. The head is installed on the can. The pressure-releasing pipe is movably installed on the head. The cap is installed on the head. The button is made independent of the cap and installed on the pressure-releasing pipe within the cap.

Other objectives, advantages and features of the present invention will be apparent from the following description referring to the drawings.

### BRIEF DESCRIPTION OF DRAWINGS

The present invention will be described through detailed illustration of the preferred embodiment in comparison with the prior art referring to the drawings.

FIG. 1 is a perspective view of a sprayer according to the preferred embodiment of the present invention.

FIG. 2 is an exploded partial view of the sprayer shown in FIG. 1.

FIG. 3 is a cross-sectional partial view of the sprayer shown in FIG. 1.

FIG. 4 is a cross-sectional partial view of a first conventional sprayer.

FIG. 5 is a cross-sectional partial view of a second conventional sprayer with a pressure-releasing pipe that is too long.

FIG. 6 is a cross-sectional partial view of a third conventional sprayer with a pressure-releasing pipe that is too short.

FIG. 7 is a cross-sectional partial view of a fourth conventional sprayer with a head that is too high.

FIG. 8 is a cross-sectional partial view of a fifth conventional sprayer with a head that is too short.

### DETAILED DESCRIPTION OF PREFERRED EMBODIMENT

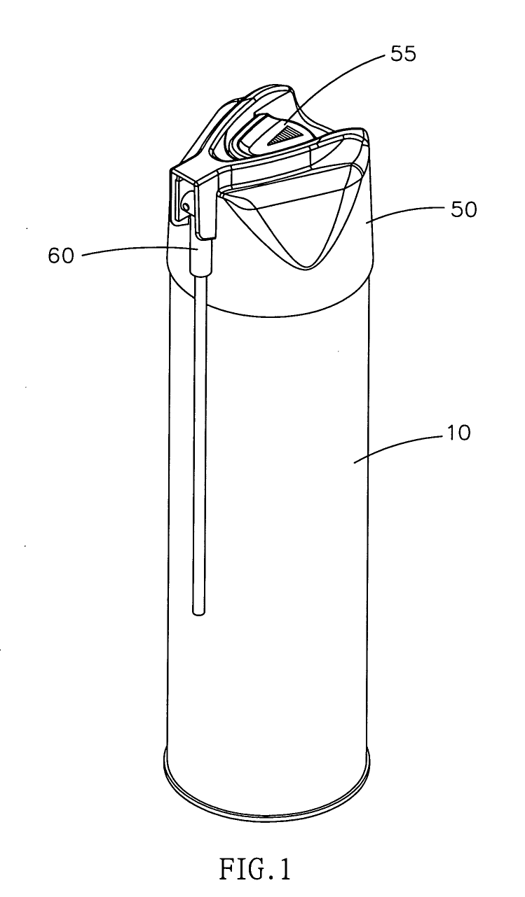

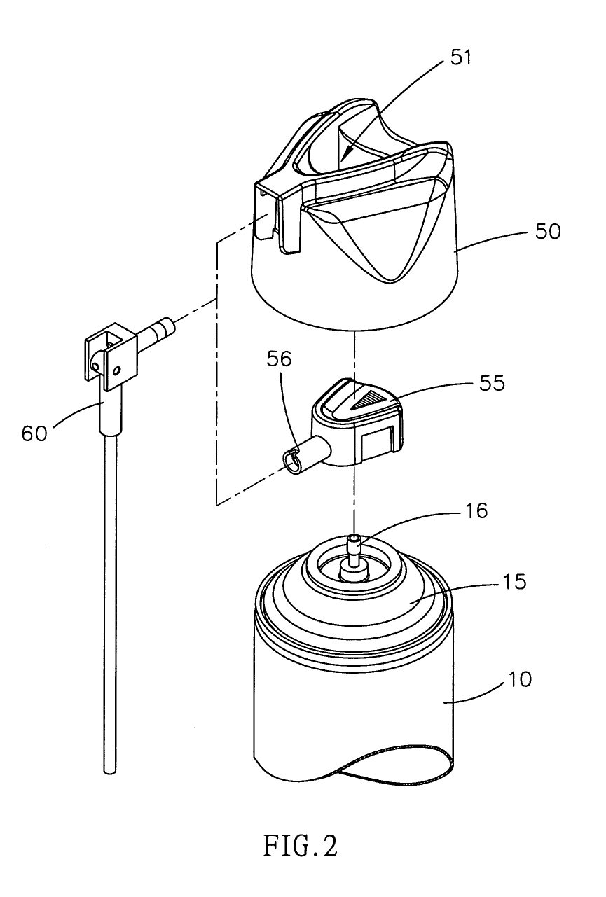

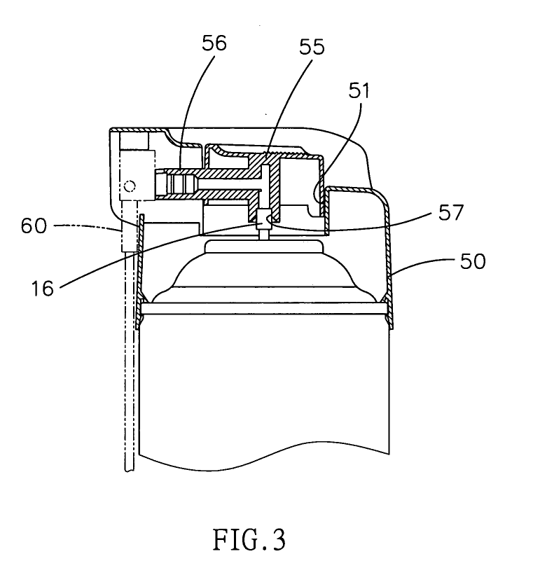

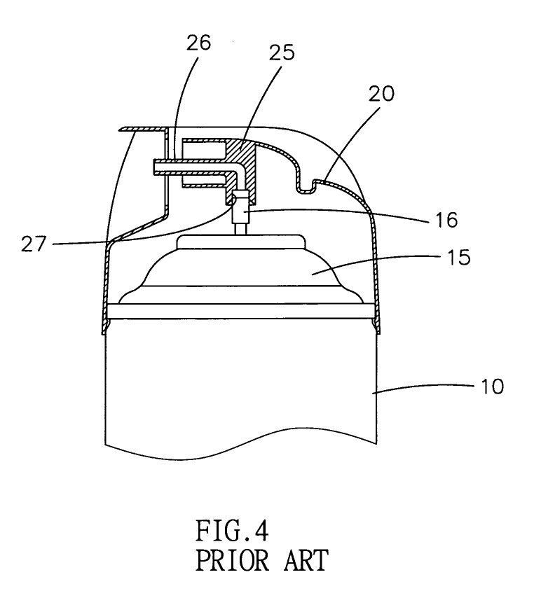

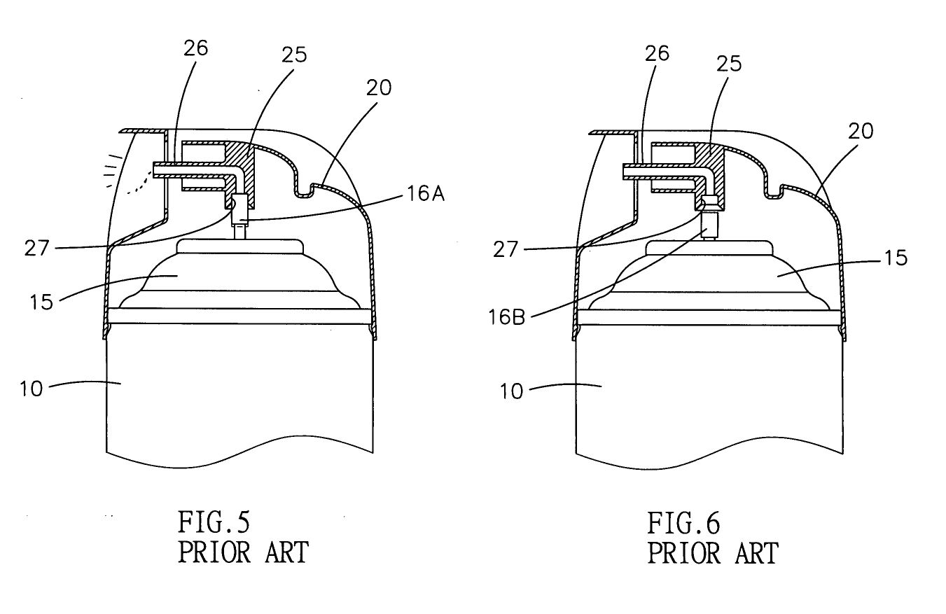

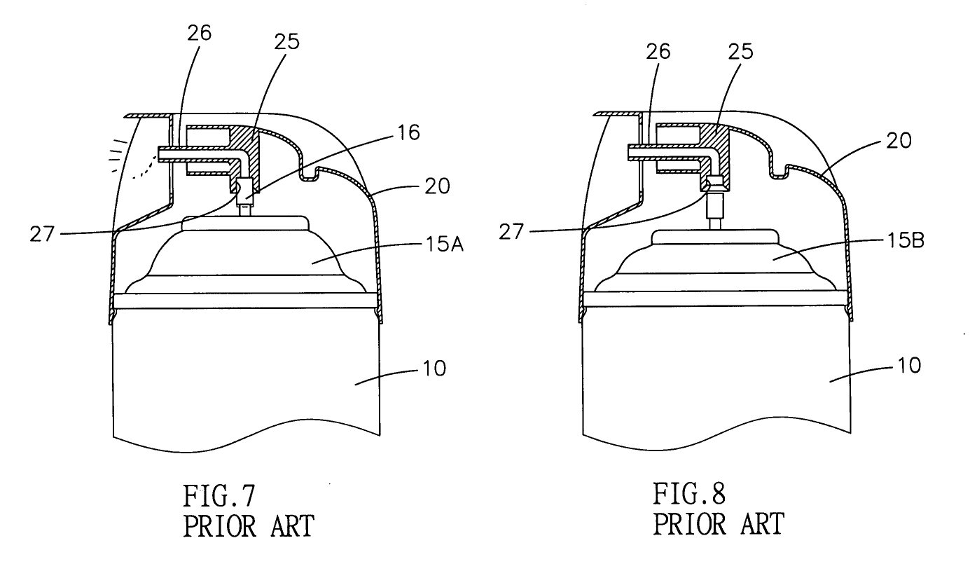

Referring to FIGS. 1 through 3, there is shown a sprayer according to the preferred embodiment of the present invention. The sprayer includes a can 10, a head 15 installed on the can 10 and a pressure-releasing pipe 16 movably installed on the head 15.

Before sealed by the head 15, the can 10 is filled with pressurized gas and liquid. The liquid may be medicine, oil, paint or any other proper liquid. When pushed, the pressure-releasing pipe 16 releases the pressurized gas from the can 10. While traveling from the can 10, the pressurized gas carries the liquid.

The sprayer includes a cap 50 installed on the can 10, a button 55 made separated from the cap 50 and installed on the pressure-releasing pipe 16 and an extensive pipe 60 connected to the button 55.

The cap 50 defines an aperture 51 within which the button 55 is located movably.

The button 55 is formed with an intake 57 for receiving the pressure-releasing pipe 16 and an outlet 56 extending from the cap 50. The intake 57 is in communication with the outlet 56.

The button 55 is made separate from the cap 50. The button 55 is installed on the pressure-releasing pipe 16 and movable within the aperture 51. That is, the button 55 is installed on the pressure-releasing pipe 16 independent of the cap 50. Therefore, proper installation of the button 55 on the pressure-releasing pipe 16 and proper operation of the pressure-releasing pipe 16 through the button 55 are ensured no matter the pressure-releasing pipe 16 is too long or short and/or the head 15 is too high or short.

The extensive pipe 60 can be pivoted. When pointed downwards, the extensive pipe 60 stops the liquid and the pressurized air. When directed horizontally, the extensive pipe 60 lets go the liquid and the pressurized air. The liquid and the pressurized air travel farther with the extensive pipe 60 than without.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A sprayer comprising a can, a head installed on the can, a pressure-releasing pipe movably installed on the head, a cap installed on the head and a button made independent of the cap and installed on the pressure-releasing pipe within the cap.

2. The sprayer according to claim 1 wherein the cap defines an aperture within which the button is located movably.

3. The sprayer according to claim 1 wherein the button comprises an intake for receiving the pressure-releasing pipe and an outlet extending from the cap.

4. The sprayer according to claim 1 comprising an extensive pipe connected to the button.
